(19) United States
(12) Patent Application Publication
(10) Pub. No.: US 2024/0419697 A1
(43) Pub. Date: Dec. 19, 2024

(54) COLLABORATIVE ASSISTANCE PLATFORM

(71) Applicant: International Business Machines Corporation, Armonk, NY (US)

(72) Inventors: Pankaj Dhoolia, Ghaziabad (IN); Muhtar Burak Akbulut, Waban, MA (US); Sachindra Joshi, Gurgaon (IN); Arnesh Batlaw, New York, NY (US); David Amid, Modiin (IL); Tom Roach, Cambridge (GB); Andy James Stoneberg, Clarksburg, MD (US); Dan O'Connor, Milton, MA (US); Venkat Raghavan Ganesh Sekar, Lowell, MA (US); Robert Leslie Yates, Arlington (GB); James William Murdock, IV, Amawalk, NY (US)

(73) Assignee: International Business Machines Corporation, Armonk, NY (US)

(21) Appl. No.: 18/209,758

(22) Filed: Jun. 14, 2023

(51) Int. Cl. G06F 16/332

(52) U.S. Cl. CPC G06F 16/3329

(57) ABSTRACT

A computer-implemented method comprises generating an event from a task demonstration within a digital channel, forming a collaboration context based on the event, defining a collaboration by associating an assistive action with the collaboration context, transforming the collaboration context into a conversational model, evaluating an interaction session within the digital channel for an interaction that matches the collaboration context, and upon detection of the interaction that matches the collaboration context, providing the assistive action corresponding to collaboration context.

### BACKGROUND

The present invention relates generally to virtual assistance. More particularly, the present invention relates to a method, system, and computer program for a collaborative assistance platform.

A virtual assistant is a software application designed to provide assistance and perform tasks for individuals or businesses. Virtual assistants exist in many different facets of everyday life and may aid humans to accomplish a variety of different tasks. In general, a virtual assistant utilizes artificial intelligence (AI) and natural language processing (NLP) technologies to understand and respond to user queries and/or commands.

Virtual assistants are typically accessed through devices such as smartphones, tablets, or computers. Virtual assistants may perform a wide range of tasks based on their design and capabilities, such as answer questions, provide information, schedule appointments, set reminders, make phone calls, send messages, provide weather updates, play music, place online orders, and/or control other devices, e.g., smart home devices.

Virtual assistants may be integrated with digital channels, e.g., websites, desktop applications, mobile applications, etc. to provide users assistance while those users access those digital channels. Virtual assistants are often integrated into digital channels in the form of chatbots. Accordingly, chatbots may be programmed to handle a wide range of tasks and inquiries, such as answering frequently asked questions, providing product information, assisting with customer support, collecting user data, and/or processing transactions.

To interact with a chatbot, a user typically enters a question or request into a chat interface. Upon receiving the input, the chatbot analyzes the input, interprets the user's intent, and generates an appropriate response based on its programming and available information. The response often may be in the form of text, images, links, or interactive elements like buttons or menus. Chatbots are designed to improve customer experience, increase engagement, and provide efficient self-service options.

### SUMMARY

The illustrative embodiments provide for a collaborative assistance platform. An embodiment includes a computer-implemented method that includes generating an event from a task demonstration within a digital channel. The embodiment also includes forming a collaboration context based on the event. The embodiment also includes defining a collaboration by associating an assistive action with the collaboration context. The embodiment also includes transforming the collaboration context into a conversational model. The embodiment also includes evaluating an interaction session within the digital channel for an interaction that matches the collaboration context. The embodiment also includes providing the assistive action upon detection of the interaction that matches the collaboration context. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for integrating the process software into a client, server, and network environment in accordance with an illustrative embodiment;

FIG. 3 depicts a block diagram of an example system for providing a collaborative assistance platform in accordance with an illustrative embodiment;

FIG. 4 depicts a block diagram of an abstracted model architecture for configuring an example collaborative assistance platform in accordance with an illustrative embodiment.

FIG. 5 depicts a block diagram of an abstracted model architecture for defining an example collaboration mapping in accordance with an illustrative embodiment;

FIG. 6 depicts a flowchart of an example process for providing collaborative assistance in accordance with an illustrative embodiment;

FIG. 7 depicts a block diagram of an example asynchronous system for providing collaborative assistance in accordance with an illustrative embodiment; and

FIG. 8 depicts a block diagram of an example synchronous system for providing collaborative assistance in accordance with an illustrative embodiment.

### DETAILED DESCRIPTION

There currently exist virtual assistants that are configured to perform a variety of tasks and provide a plethora of information. However, a problem exists that currently existing virtual assistants do not provide assistance in situations where a user may actually desire some assistance. Instead, virtual assistants may perform actions and/or provide information independent of a context of user's interaction within a digital channel. Currently there is no way for a virtual assistant to proactively provide collaborative assistance to a user of a digital channel.

The present disclosure addresses the deficiencies described above by providing a process (as well as a system, method, machine-readable medium, etc.) that provides a collaborative assistance platform. Disclosed embodiments combine user interaction analytics with artificial intelligence (AI) and natural language processing (NLP) to provide a collaborative virtual assistant that is configured to proactive provides collaborative assistance to a user of a digital channel.

The illustrative embodiments provide for a collaborative virtual assistance platform. A virtual assistant as referred herein is a computer program designed to provide assistance to a user. Embodiments disclosed herein describe the virtual assistant as a chatbot; however, use of this example is not intended to be limiting, but is instead used for descriptive purposes only.

As used throughout the present disclosure, the term “digital channel” refers to a medium through which digital content and/or communications may be delivered to a user. Further, a digital channel refers to a communication pathway, system, application, and/or platform that handles digital signals between users, and/or between a user and a system. An example of a digital channel may include, but is not limited to, an online platform, website, mobile application, social media network, email, search engine, messaging application, etc.

As used throughout the present disclosure, the term “event” refers to an action, behavior, and/or occurrence that takes place over a system. As used throughout the present disclosure, the term “analytics event” refers to a specific occurrence or action that is tracked and recorded on a system that may be used for the purpose of analysis of a system. Further, an analytics event represents a data point that may provide information about user behavior, system performance, and/or any other relevant aspect that an analyst and/or organization may desire to observe. For example, in the realm of web analytics, an analytics event may include, but is not limited to, page views, clicks, form submissions, downloads, or any other measurable activity that occurs on a website. In the realm of mobile application analytics, an analytics event may include, but is not limited to, application launches, screen views, button taps, in-app purchases, etc. Further, an analytics event may also include structured data that includes specific attributes or properties related to the analytics event that may provide additional context and information, including but not limited to, the timestamp of the event, the user or device involved, any associated metadata, and other relevant details. By tracking and analyzing analytics events, analysts and/or organizations can gain insights into user behavior, system performance, conversion rates, user engagement, and other metrics.

As used throughout the present disclosure, the term “interaction event” refers to a specific action or behavior performed by a user within a digital system, e.g., a digital channel. Accordingly, an interaction event may represent a meaningful interaction between the user and the system, including but not limited to, clicking a button, submitting a form, viewing a page, playing a video, making a purchase, or any other activity that can be tracked and recorded. Further, each interaction event may include relevant information, including but not limited to, type of event, the timestamp when the event occurred, the user who performed the action, and additional contextual data. Interaction event data may be utilized for analyzing and understanding user behavior, preferences, and/or engagement patterns within the system.

It is understood that an interaction event is a type of analytics event. Further, it is contemplated that analytics events include additional other types of events that provide data for analysis. Accordingly, an analytics event may include other events in addition to user interaction events, including, but not limited to, system events, errors, performance metrics, or any other relevant data point that may be tracked and recorded for analysis. For example, system events may include server logs, API calls, background processes, etc. Error events may include capture exceptions, crashes, etc. Performance events may include metrics related to page load times, latency, network requests, etc. Accordingly, interaction events refer to user actions and behaviors, while analytics events encompass a broader range of tracked occurrences, including user interactions, system events, errors, performance metrics, etc.

As used throughout the present disclosure, the term “collaboration context” refers to a set of conditions based on the existence of events within a digital channel that when met actuate an assistive action. As used throughout the present disclosure, the term “assistive action” refers to an action that is actuated upon meeting a set of conditions forming a collaboration context. As used throughout the present disclosure, a “collaboration” is a mapping defining a collaborative context with an assistive action. Accordingly, when a user of a digital channel interacts with the digital channel in a manner so that the collaborative context is satisfied, an assistive action is triggered upon the satisfaction of that collaboration context, and the user is provided with collaborative assistance. The specific collaborative assistance that may be provided to the user may include, but is not limited to, providing an answer to a question, playing a demonstration video, describing the purpose of an interaction, auto filling a text input box, and/or calling an action.

As used throughout the present disclosure, the term “conversational model” refers to a system and/or approach that is designed to engage in natural language conversations with a user of a digital channel. Accordingly, a conversational model may simulate human-like conversation and provide intelligent responses to a user query or prompt. Conversational models are typically based on artificial intelligence (AI) techniques, such as natural language processing (NLP) and machine learning, to understand and generate human-like responses. An example embodiment of a conversational model may include, but is not limited to, a chatbot, a virtual assistant, a voice assistant, and/or dialogue systems. It is understood that conversational models may be utilized in applications, platforms, and services to facilitate interactions between users and computer systems in a conversational manner.

Illustrative embodiments include a generating at least one event from a task demonstration within a digital channel. In some such embodiments, the digital channel may be instrumented to enable the digital channel to generate the at least one event from a task demonstration. Further, in some such embodiments, a programming by demonstration technique may be utilized to record events that are generated from the task demonstration. Accordingly, a Subject Matter Expert (SME) may perform a demonstration of a task over a digital channel, and the demonstration of a task may include the at least one interaction event.

Illustrative embodiments further include forming at least one collaboration context based on at least one event. The at least one event may be the at least one event generated during a task demonstration by an SME. Further, at least one collaboration may be defined by associating at least one assistive action with the at least one collaboration context.

Illustrative embodiments further include transforming at least one collaboration into a conversational model. In some such embodiments, the conversational model may be utilized by a virtual assistant configured to assist a user attempting to accomplish a certain task while interacting with the digital channel. Accordingly, the virtual assistant may be configured to provide collaborative assistance to a user of a digital channel by way of providing an assistive action upon the user satisfying a set of conditions of a collaboration context.

Illustrative embodiments further include evaluating an interaction session of a user within the digital channel. Evaluating the interaction session may include determining that at least one user interaction during the interaction session that matches at least one collaboration context and providing the at least one assistive action corresponding to the at least one collaboration context upon a determination that the at least one user interaction matches the at least one collaboration context. In some such embodiment, user interaction(s) may be continuously evaluated during a user interaction session to evaluate whether any user interactions match any collaboration contexts that are associated with certain corresponding assistive actions. In some such embodiments, providing the at least one assistive action may include, but is not limited to, providing an answer to a question, playing a demonstration video, describing a purpose of the at least one user interaction, and calling an action.

Illustrative embodiments further include configuration of an event listener, wherein the event listener may be configured to transmit events generated within the digital channel to an event database. The events generated within the digital channel may be utilized to create collaboration contexts via a collaboration surface interface. In some embodiments, the event listener is embedded in the digital platform. In some embodiments, the event listener is embedded in the virtual assistant.

The process software, including the collaborative assistance software, may be integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

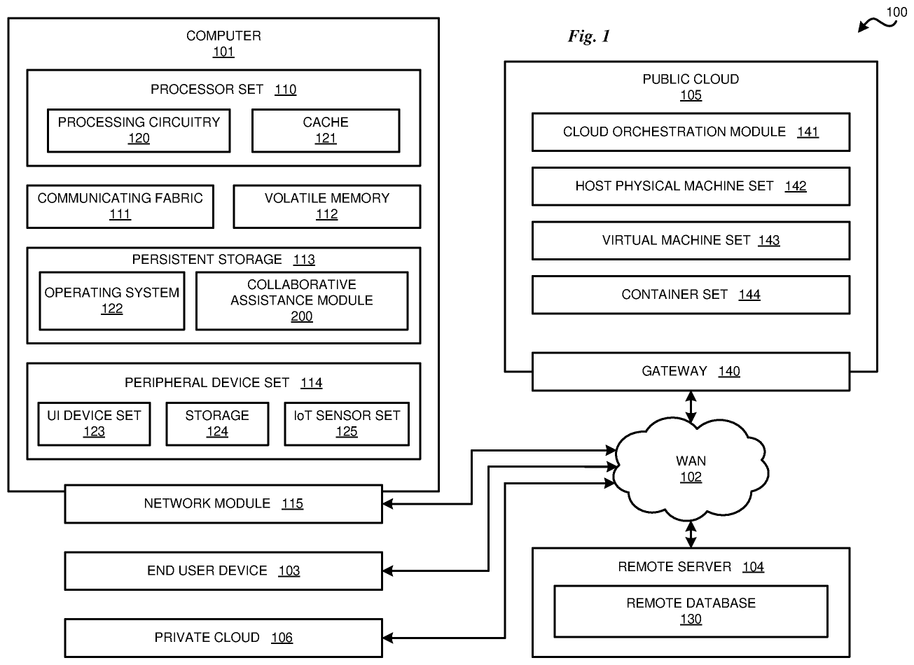

With reference to FIG. 1, this figure depicts a block diagram of a computing environment 100. Computing environment 100 contains an example of an environment for the execution of at least some of the computer code involved in performing the inventive methods, such as providing a collaborative assistance platform that includes configuring a virtual assistant to provide collaborative assistance to a user of a digital channel. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

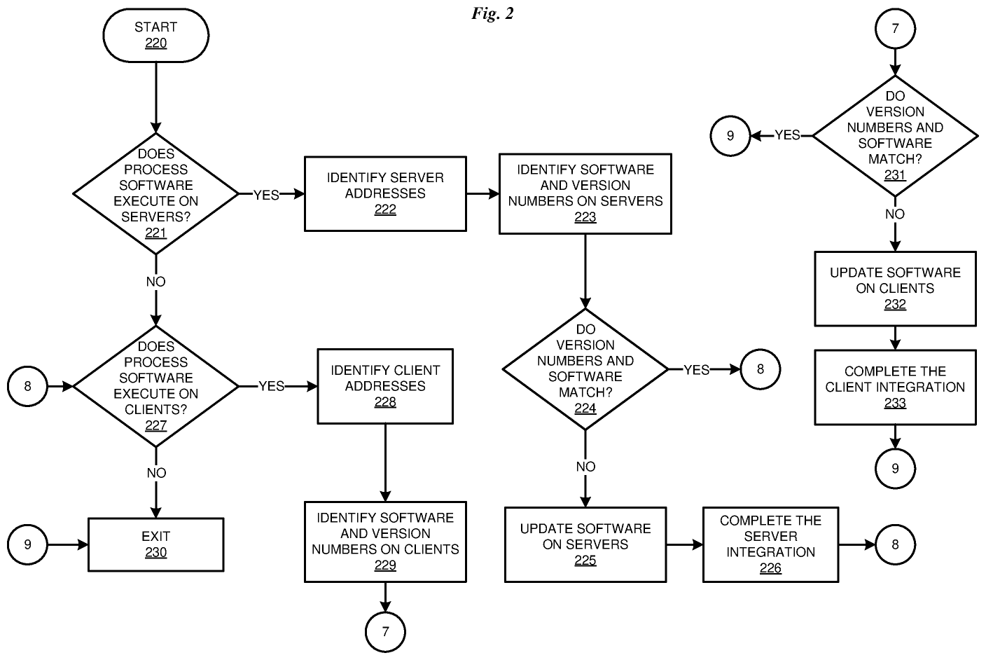

With reference to FIG. 2, this figure depicts a flowchart of an example process for integrating the process software into a client, server, and network environment.

Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

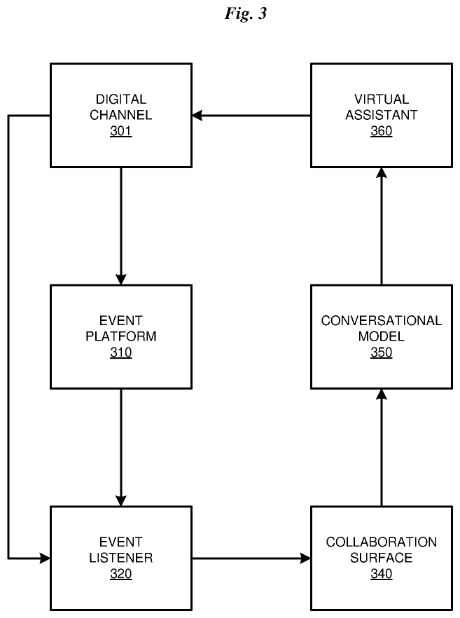

With reference to FIG. 3, this figure depicts a block diagram of example system for providing a collaborative assistance platform in accordance with an illustrative embodiment.

In the illustrated embodiment, digital channel 301 is any digital channel that a user may interact with, including but not limited to, a website, a web-application, a desktop application, a mobile application, etc. Further, the digital channel 301 includes an interface that enables a user to interact with digital channel 301. Further, the digital channel 301 may include any number of features, objects, and/or elements that a user may interact with, including but not limited to, links, menus, buttons, text input boxes, interactive media, etc. It is understood that any user interaction that is exhibited by a user interacting with the digital channel may be considered an event. Accordingly, these events may be tracked and recorded to gather insights into user behavior, performance, and user engagement with the digital channel 301. Accordingly, an event herein refers to any user engagement with digital channel 301, including, but not limited to, pageviews, clicks, form submissions, conversions, scroll tracking, time on page, error tracking, social sharing, etc. Further examples of interaction events may include, but are not limited to, clicking a link, clicking an object or element on the digital channel 301, entering information into a text input box, etc.

In the illustrated embodiment, the event platform 310 is configured to receive an event or events from digital channel 301. For example, in a scenario where the digital platform 301 is a website, when a user clicks a link on a website, the event of that user clicking the link on the website is recorded and sent to the event platform 310. The event platform 310 may store all of the events that take place over digital channel 301. In some embodiments, the event or events are stored in an event database (not shown). Event platform 310 may be configured or designed to allow a user to analyze and visualize events that take place over digital channel 301, to enable the user to optimize the design of the digital channel 301. In some embodiments, digital channel 301 may be instrumented to observe, detect, record, and/or transmit events to the event platform 310. In some embodiments, instrumentation may be embedded into the digital channel 301 to enable the digital channel 301 to observe, detect, record, and/or transmit events and/or event-related data to event platform 310.

In the illustrated embodiment, the event listener 320 may receive events and/or event-related data from the digital channel 310. In some embodiments, the event listener 320 may receive events and/or event-related data via the event platform 310. In some other embodiments, the event listener may receive events and/or event-related data directly from the digital channel 301. In some embodiments, the event listener 320 is registered as a destination for receiving events and/or event-related data in event platform 310. In some embodiments, the event listener 320 may be embedded into the digital channel 301.

Further, to enable analysis of user engagement, digital channel 301 may utilize event platform 310 and an accompanying code library or libraries to generate an event or events associated with a user interaction or interactions. An event library may enable event-related data to be sent to remote storage locations, e.g., cloud-based storage in real-time, from where the event platform 310 may send these events to various other registered destinations. In one embodiment, the event listener 320 may be a webhook that may be registered as a destination in the event platform 310 being used by the digital channel 301.

The illustrated embodiment utilizes events at least for the purpose of ultimately providing collaborative assistance to a user in the context of the user's interactions with digital channel 301. The extent to which collaborative assistance may be provided may be based in part upon a number of possible collaborations. Accordingly, the spectrum of collaboration possibilities may be based in part on the granularity of events. Granularity and granularity-related terms, as described herein, refer to the resolution of a task based on the number of events that exist within the context of the performance of that certain. For example, a coarse event granularity profile may generate an event or events for a start and end of a task, a medium granularity event profile may additionally generate an event or events for an intermediate milestone or milestones in a task, and a granular event profile may generate an event or events for every possible user interaction in the task. It is contemplated that, depending on the nature of collaboration with regard to an existing event generation profile, instrumentation may be included to generate additional events.

In one embodiment, when event listener 320 is in communication with digital platform 301, either directly or via event platform 310, a Subject Matter Expert (SME) may demonstrate a task for which an event or events may be recorded. Accordingly, as the SME demonstrates the task, an interaction event or events may be generated and sent to the event platform 310, and from event platform 310 the event or events may be sent to the event listener 320 destination. In some embodiments, the process of recording an event or events via a SME may be accomplished via a Programming by Demonstration (also known as “Record and Playback) technique.

In some embodiments, the Programming by Demonstration technique may be accomplished in part by utilizing a recording application and/or a web-browser plugin to track interactions of the SME. Further, in some such embodiments, interaction details that are recorded may include, but are not limited to, DOM elements, properties, and/or types of interaction, including but not limited to, selection, input, click, etc.

In some embodiments, interaction events may be recorded without the use of a recording application and/or web-browser plugin. Accordingly, semantic constructs as used by analytics may be utilized to record events. It is contemplated that using semantic construct as used by analytics enables the event-related data to be semantically meaningful data added for analytics. In contrast, the embodiment utilizing a recording application and/or a web-browser plugin may utilize structural constructs (i.e., DOM elements and properties). Accordingly, it is further contemplated that an embodiment utilizing semantic construct is independent and/or invariable to DOM elements. Further, it is contemplated that since the analytics may be utilized, no special recording application and/or web-browser plugin may be required by the system and method. In one embodiment, a code library introduced by instrumenting the digital channel generates related events. Accordingly, embodiments of the present invention include a combination of Programming by Demonstration and utilization of a sequence of analytics events generated via Programming by Demonstration to model and provide event-based collaborative assistance.

In the illustrated embodiment, collaboration surface 340 depicts an exemplary platform including an interface to enable a user to define collaborations, as described in greater detail herein. In an embodiment, when an analytics event is received by the collaboration surface 340, the collaboration surface may be utilized to determine a collaboration context based on the analytics event. Examples of events may include, but are not limited to, be clicking a button, link, textbox, object, element, etc. on a webpage. Accordingly, if a sequence of events includes clicking a particular textbox, then defining a collaboration context may include the condition of clicking that particular textbox. Further, collaboration surface 340 may enable associating an assistive action that may be provided when a condition of a collaboration context is met. For example, suppose the collaboration context is specified as clicking a textbox, in which case the corresponding assistive action may be providing clarification on what kind of information should be entered into that textbox. A collaboration context mapped with an associated assistive action may be collectively referred to as a collaboration.

In the illustrated embodiment, the collaboration mapping constructed utilizing collaboration surface 340 may be transformed into a conversational model 350. Accordingly, conversational model 350 is designed to simulate human conversation, as described herein. Conversational model 350 may be a retrieval-based model, a generative model, and/or any combination thereof. Further, conversational model 350 may be constructed based in part on the collaboration mapping. Accordingly, conversational model 350 may provide assistive actions in the form of conversational dialogue to a user of digital channel 301. It is contemplated that providing a user with assistive actions via a conversational dialogue may enable easier and better understanding of the task at hand by the user.

In some embodiments, the collaboration mapping may be transformed into the conversational model 350 in the following exemplary manner. A collaboration routing action may be dedicated to evaluate a user interaction session of a user interacting with digital channel 301 and provide an assistive action upon matching a user interaction with the collaborative context defined by the collaboration mapping.

In one embodiment, a reference to a new assistive action that is created from a name, and intent may be derived from the collaboration. It is contemplated herein that such embodiment may be suitable for a wrapper-based solution around a chat client widget that might provide limited configurability. Accordingly, the wrapper-based solution may include a wrapper around a chat widget, wherein the wrapper around the chat widget is configured to receive push-based output. Accordingly, the wrapper may utilize chat client widget instance to send a fresh sync request using the reference to the new assistive action.

In another embodiment, the system, method, program, etc. may utilizes asynchronous actions and push-based output. Accordingly, the system, method, program, etc. may directly perform and return the output of an assistance handler defined as part of the collaboration. It is contemplated herein that such embodiment may be suitable for a chat client widget that supports push-based output and asynchronous actions, and that may render assistance based on a push-based notification.

In the illustrated embodiment, the virtual assistant 360 may utilize the conversational model 350 for proactively providing collaborative assistance. Further, virtual assistant 360 may be employed with and/or integrated with the digital channel 301. In an embodiment, the virtual assistant is IBM® Watson® Assistant. (IBM®, Watson®, and Watson-related terms are trademarks owned by International Business Machines Corporation in the United States and other jurisdictions.) In an embodiment, the virtual assistant 360 is displayed alongside or within digital channel 301, ready to provide collaborative assistance in any instance that a set of conditions defining a collaboration context is met, thereby triggering an assistive action to be actuated. For example, suppose a user clicks a textbox labeled “Annual Income”, then the virtual assistant 360 may provide a dialogue box that provides a description of how to calculate annual income, for the user to view. In this manner, the virtual assistant proactively provides collaborative assistance to a user interacting with the digital channel 301.

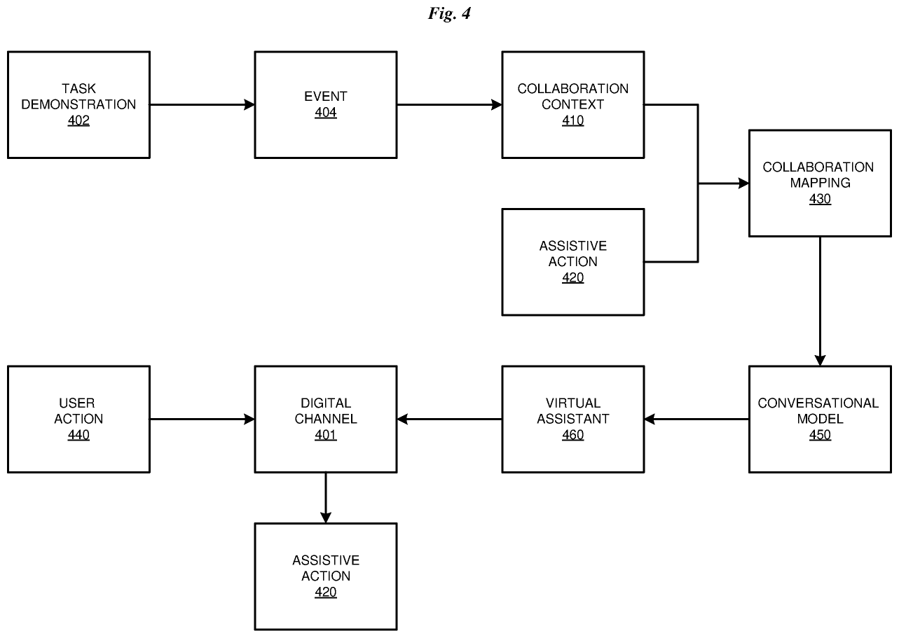

With reference to FIG. 4, this figure depicts a block diagram of an abstracted model of an example configuration for defining a collaboration mapping.

In the illustrated embodiment, task demonstration 502 includes performing a task over a digital channel by a Subject Matter Expert (SME), wherein the demonstration of the task generates an event or events. In some embodiments, tasks are generated during task demonstration 502 by a SME via a Programming by Demonstration technique. In the illustrated embodiment, event 402 is an interaction event including any type of user engagement that may be exhibited by the user of a digital channel. Accordingly, as shown in FIG. 4, task demonstration 402 is performed by an SME to generate at least one event 404.

In the illustrated embodiment, collaboration context 410 includes the details of the certain conditions that may be met in order to trigger the actuation of an assistive action 420. Accordingly, the collaboration context 410 refers to a set of conditions that when met cause an assistive action 420 to be actuated. Collaboration mapping 430 may include a plurality of collaboration contexts corresponding to a plurality of assistive actions, respectively. Accordingly, collaboration context may be an input set of conditions, that when met, produce an output assistive action corresponding to the collaboration context. An assistive action may include at least one of a plurality of potential assistive actions.

In the illustrated embodiment, the collaboration context 410 and the assistive action 420 collectively form a collaboration mapping 430, wherein meeting the conditions of a certain collaboration context may actuate an assistive action associated the collaboration context in response. In accordance with the previous example, a collaboration context may include clicking a textbox titled “Net Worth.” Upon clicking the textbox titled “Net Worth”, an assistive action may be triggered. In accordance the example, the assistive action corresponding to that collaboration context may include providing an explanation for how to calculate net worth.

In the illustrated embodiment, a user action 440 from a user engaging with a digital channel 401 is shown. When the user interacts with the digital channel 401, the user interaction session may include a user action 440 that may trigger an assistive action 420. Accordingly, the assistive action 420 is configured to assist the user based on the user action 440 that was performed within the digital channel 401. For example, if the user action 440 includes clicking a textbox to enter text to answer a question of an online form, the assistive action may include providing guidance on how to answer the question that is being asked.

The assistive action 420 may include one or more types of assistive actions. The types of assistive actions may include, but are not limited to, providing an answer to a question, playing a demonstration video, describing the purpose of an interaction, auto filling a text input box, and/or calling an action. A collaboration routing action may be utilized to evaluate a particular context and provide assistance based on the context. Further, for each collaboration, a new step may be added to the collaboration routing action with each step condition based on the collaboration context.

In the illustrated embodiment, the collaboration mapping 430 is transformed into a conversational model 450. The conversational model 450 is an example embodiment of conversational model 350 of FIG. 3. Virtual assistant 460 is an example embodiment of virtual assistant 360 from FIG. 3.

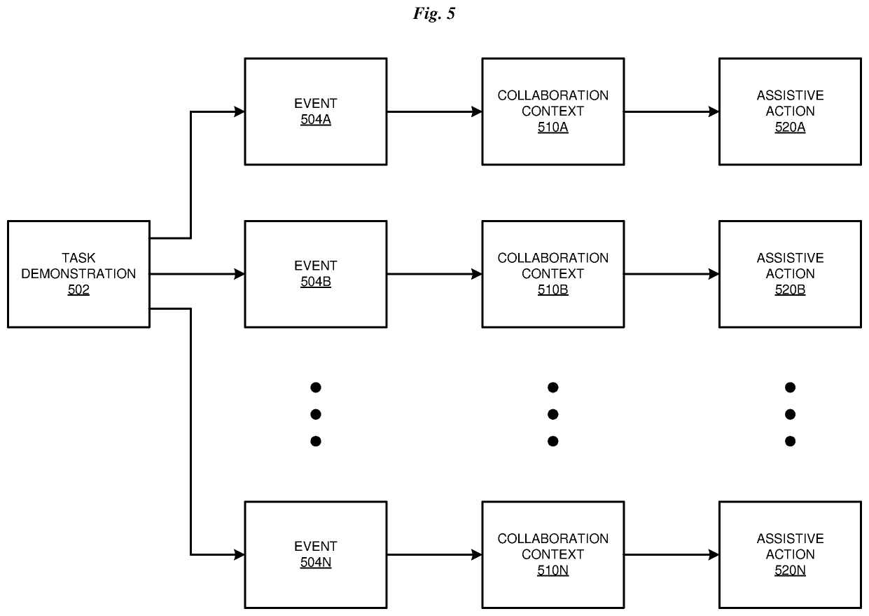

With reference to FIG. 5, this figure depicts an abstracted model architecture for defining an example collaboration mapping in accordance with an illustrative embodiment. Task Demonstration 502 is an example embodiment of task demonstration 401 of FIG. 4. Task demonstration 502 represents an example demonstration of a task by a Subject Matter Expert (SME). Accordingly, an SME demonstrates a task on a digital platform, and the task demonstration 501 generates one or more events, such as, for example, event 502a, 502b, and 502n. Although FIG. 5 depicts three events generated from Task Demonstration 501, it is contemplated that Task Demonstration 501 may cause the generation of any number of events.

Further, in accordance with the illustrated embodiment, collaboration context 510a, collaboration context 510b, and collaboration context 510n are shown as created based in part on event 402a, 402b, and 402n, respectively. Further, assistive action 520a, 520b, and 520n are shown corresponding to collaboration context 510a, 510b, and 510n, respectively. Suppose during a task demonstration 502, the SME clicks a link to open a web-page, clicks a textbox on the web-page, and enters some text into the textbox. In such supposed scenario, clicking the link to open the web-page may be event 502a, clicking the textbox on the web-page may be event 502b, and entering text into the textbox may be event 502n. Based on those generated events, collaboration context 510a may include in the form of a condition the action of clicking the link to open the web-page, collaboration context 510b may include in the form of a condition the action clicking the textbox on the web-page, and collaboration context 510n may include in the form of a condition entering text into the textbox.

Further, in accordance with the illustrated embodiment, based on those defined collaboration contexts, assistive actions 520a, 520b, and/or 520n may be triggered upon meeting the conditions set by collaboration context 510a, 510b, and/or 510n. Accordingly, if a user presses a specific link to open a web-page, assistive action 520a may include, for example, playing an explanatory introduction video describing the purpose and/or desired actions to be taken on that web-page by the user. If a user clicks a specific textbox, assistive action 520b may include, for example, an explanation of what kind of information is sought to be entered into the textbox. If a user enters text into a specific textbox, assistive action 510n may include, for example, auto-fill the remainder of the input text.

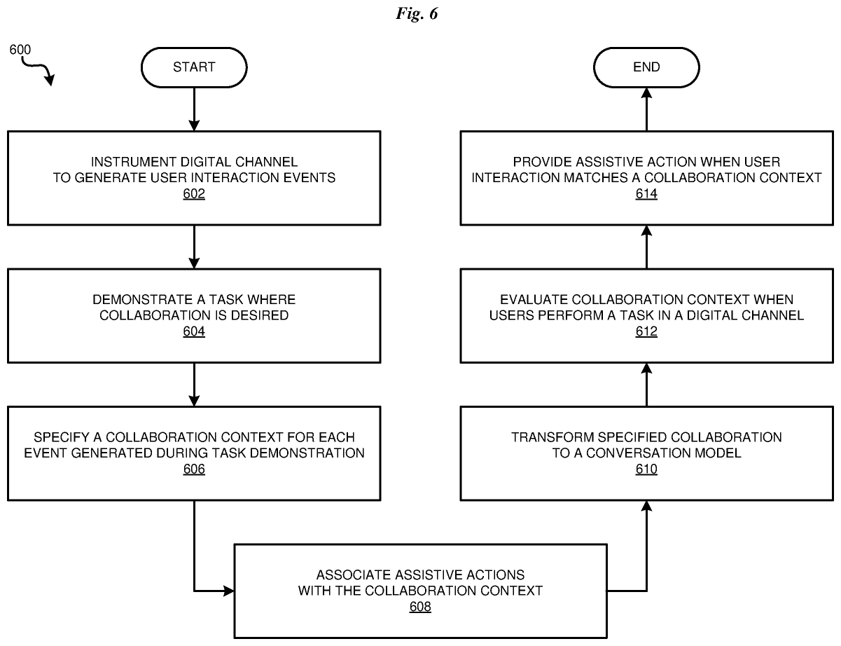

With reference to FIG. 6, this figure depicts a flowchart of example process 600 for providing virtual collaborative assistance. In a particular embodiment, the collaborative assistance module 200 of FIG. 1 carries out process 600.

In the illustrated embodiment, at block 602, the process instruments a digital channel to generate relevant user interaction events. It is contemplated that block 602 may be omitted in the process. Further, it is contemplated that the digital channel may already be previously configured to generate and/or transmit events and/or event-related data.

At block 604, a task is demonstrated on the digital channel. In some embodiments, a subject matter expert (SME) performs a task demonstration. Accordingly, as the SME demonstrates the task, at least one interaction event may be generated and sent to an event platform, and subsequently sent to a collaboration surface. In some embodiments, the at least one task generated during the task demonstration is directly sent to a collaboration surface. It is contemplated that the generation and transmission of events and/or event-related data may depend on the particular instrumentation configured with the digital channel. In some embodiments, events are generated during the task demonstration via a Programming by Demonstration (also known as “Record and Playback” technique).

In some embodiments, an interaction event or events generated during task demonstration may include an identifier that uniquely identifies an interaction session. Further, the identifier may be generated via an event library utilized to perform the task demonstration. As a nonlimiting example contemplated herein, Segment® events have an attribute named “anonmyous_user_id”, and the value of that attribute identifies a particular interaction session. (Segment®, and Segment-related terms are trademarks owned by SEGMENT.IO, INC. in the United States and other jurisdictions.) In some embodiments, the SME may set a special identity prior to demonstrating a task. This special identity may be utilized to filter the event stream, i.e. organize the sequence of events when defining collaborations.

In some embodiments, the SME may declare the completion of a task demonstration. In some such embodiments, the SME may receive an identifier that corresponds to that task demonstration upon the completion of the task demonstration. In a particular embodiment where Segment is utilized, the SME receives the “anonymous_user_id” corresponding to the task demonstration, which may be useful for identifying the task demonstration.

At block 606, the process specifies a collaboration context for each event generated during the task demonstration. In some embodiments, collaboration context may be defined via a collaboration surface interface. In accordance with the present disclosure, a collaboration surface refers to a platform for utilizing a sequence of interaction events generated during a task demonstration to define collaborations. Accordingly, each event in the interaction sequence is a point on the collaboration surface where an assistant may provide or seek assistance to help a user complete a task.

A collaboration context refers to a condition on the state of interaction for a task. Accordingly, a collaboration context may include a conditional expression on an event and the data contained within said event. In some embodiments, a condition may be defined by specifying a target event. Accordingly, a target event refers to a logical construct that captures the specific interaction in the context of which collaborative assistance may be provided. For example, the target event may be a user visiting a certain section of a web-page. Further, a condition may include the existence of a target-event. Further, a condition may include the existence of a target-event-data. In some embodiments, the process further includes specifying a companion event associated with the collaboration context. A companion event refers to logical construct that may be used to provide additional pre-requisite context to the target event.

At block 608, the process associates at least one assistive action for at least one collaboration context, forming at least one collaboration. The assistive action refers to a specific action that is actuated upon triggering of a collaboration context. In an embodiment, the assistive action may include suggesting a video for a user to watch. Accordingly, the SME can specify a video that the assistant may proactively suggest when a user is in an appropriate task context. The association of a collaboration context with an assistive action collectively forms a collaboration mapping, also referred to simply as a collaboration.

At block 610, the process transforms the at least one collaboration into a conversational model. The conversational model may be embodied as or otherwise utilized by a virtual assistant configured to assist a user attempting to accomplish a certain task while interacting with the digital channel. Accordingly, the virtual assistant employing the conversational model may be configured to provide collaborative assistance to a user of a digital channel by way of providing an assistive action upon the user satisfying a set of conditions of a collaboration context.

At block 612, the process evaluates collaboration context when a user performs a task in a digital channel. Accordingly, when a user interacts with the digital channel during a user interaction session, the process evaluates whether any user interactions match a collaborative context that has been mapped to an assistive action. At block 614, the process provides at least one assistive action when a collaboration context is matched. The at least one assistive action may include, but is not limited to, providing an answer to a question, playing a demonstration video, describing a purpose of the at least one user interaction, and calling an action.

In an embodiment, the collaborative assistance provided by the virtual assistant includes automatically filling inputs in the digital channel, e.g., web-application from information available to the virtual assistant. Accordingly, in such embodiment, a list of all the inputs that events used in defining a collaboration may be displayed to the SME alongside side assistant's session variables. Further accordingly, in such embodiment, the SME may then choose to auto-fill inputs from the virtual assistant's context.

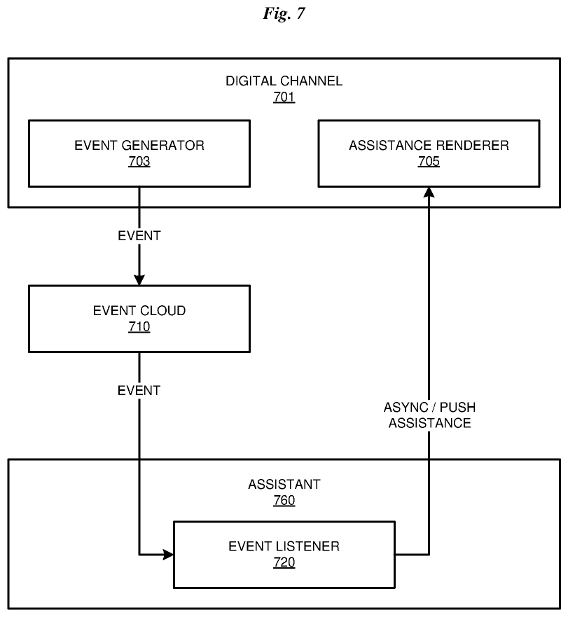

With reference to FIG. 7, this figure depicts a block diagram of an example asynchronous system for providing collaborative assistance. The system depicted by FIG. 7 includes a digital channel 701 embedded with an event generator 703 and an assistance renderer 705, an event cloud 701, and a virtual assistant 760 embedded with an event listener 720. Digital channel 701 is an example digital channel 301 from FIG. 3, and/or digital channel 401 from FIG. 4. Event cloud 710 is an example embodiment of event platform 310 of FIG. 3. Virtual assistant 760 is an example embodiment of virtual assistant 360 from FIG. 3 and/or virtual assistant 460 from FIG. 4. Event listener 720 is an example embodiment of event listener 320 from FIG. 3.

Event generator 703 may generate events on digital channel 701 based on user interactions within digital channel 701. Events that are generated by event generator 703 may be transmitted to event cloud 710. Event cloud 710 is an example storage location, such as for example, a cloud storage location. Event listener 720 may receive events from event cloud 710. Virtual assistant 760 may evaluate whether any events received by event listener 720 match a collaboration context that may provide an assistive action based upon detection of a matching event. Accordingly, events generated in the digital channel 701 may be pushed to the event cloud 810, which may transmit the events to the event listener 720. Further, upon evaluating collaboration context, assistance is asynchronously pushed to the assistance renderer 705 in the digital channel 701. Assistance renderer 705 may render the assistive action to provide collaborative assistance to the user of the digital channel 701. In some embodiments, the assistance renderer 705 is a wrapper embedded inside of a chat widget (not shown). Further, in an embodiment where the digital channel 701 as well as the virtual assistant 760 may be configurable to enable functionality of push-notification and asynchronous support, event listener 720 may be implemented as additional API webhook provided by the virtual assistant 760.

In some embodiments, the functionality described herein is distributed among a plurality of systems, which can include combinations of software and/or hardware-based systems, for example Application-Specific Integrated Circuits (ASICs), computer programs, or smart phone applications.

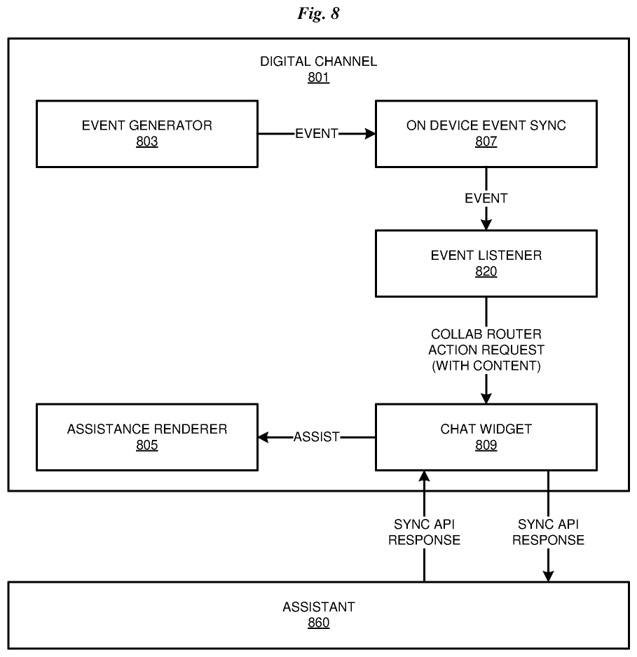

With reference to FIG. 8, this figure depicts a block diagram of a synchronous system for providing collaborative assistance. The system depicted by FIG. 8 includes a digital channel 801 embedded with an event generator 803, an on-device event sink 807, an event listener 820, a chat widget 809, and an assistance renderer 805, and a virtual assistant 860 in communication with the digital channel 801. Digital channel 801 is an example digital channel 301 from FIG. 3, and/or digital channel 401 from FIG. 4. Virtual assistant 860 is an example embodiment of virtual assistant 860 from FIG. 3 and/or virtual assistant 460 from FIG. 4. Event listener 820 is an example embodiment of event listener 320 from FIG. 3.

Event generator 803 may generate events on digital channel 801 based on user interactions within digital channel 801. Events that are generated by event generator 803 may be transmitted to on device event sink 807. Event listener 920 may receive events from event sink 807 and transmit said events to chat widget 809. Chat widget 909 is configured to request a collaboration routing from virtual assistant 860 and receive an assistive action as a response. If an assistive action is received as response, chat widget 809 may transmit the assistive action to assistance renderer 805, and assistance renderer 805 may render the assistive action to provide collaborative assistance to the user of the digital channel 801.

In some embodiments, the functionality described herein is distributed among a plurality of systems, which can include combinations of software and/or hardware-based systems, for example Application-Specific Integrated Circuits (ASICs), computer programs, or smart phone applications.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

1. A computer-implemented method comprising:
monitoring a digital channel to detect user activity;
performing a task demonstration within the digital channel;
generating, according to a granularity profile, an event stream from the task demonstration within the digital channel based on the user activity detected;
forming a collaboration context based on the event stream;
defining a collaboration by associating an assistive action with the collaboration context;
transforming the collaboration context into a conversational model;
evaluating an interaction session within the digital channel for an interaction that matches the collaboration context; and
providing the assistive action corresponding to the collaboration context via the conversational model upon detection of the interaction that matches the collaboration context.

2. The computer-implemented method of claim 1, further comprising instrumenting the digital channel to generate the event stream.

3. The computer-implemented method of claim 1, wherein evaluating the interactive session comprises continuously evaluating the interactive session while a user interacts with the digital channel.

4. (canceled)

5. The computer-implemented method of claim 1, wherein providing the assistive action comprises providing an answer to a question.

6. The computer-implemented method of claim 1, wherein providing the assistive action comprises playing a demonstration video.

7. The computer-implemented method of claim 1, wherein providing the assistive action comprises describing a purpose of the interaction.

8. The computer-implemented method of claim 1, wherein providing the assistive action comprises calling an action.

9. A computer program product comprising one or more computer readable storage media, and program instructions collectively stored on the one or more computer readable storage media, the program instructions executable by a processor to cause the processor to perform operations comprising:
monitoring a digital channel to detect user activity;
performing a task demonstration within the digital channel;
generating, according to a granularity profile, an event stream from the task demonstration within the digital channel based on the user activity detected;
forming a collaboration context based on the event stream;
defining a collaboration by associating an assistive action with the collaboration context;
transforming the collaboration context into a conversational model;
evaluating an interaction session within the digital channel for an interaction that matches the collaboration context; and
providing the assistive action corresponding to the collaboration context via the conversational model upon detection of the interaction that matches the collaboration context.

10. The computer program product of claim 9, wherein the stored program instructions are stored in a computer readable storage device in a data processing system, and wherein the stored program instructions are transferred over a network from a remote data processing system.

11. The computer program product of claim 9, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

12. The computer program product of claim 9, further comprising instrumenting the digital channel to generate the event stream.

13. The computer program product of claim 9, wherein evaluating the interaction session comprises continuously evaluating the interaction session while a user interacts with the digital channel.

14. (canceled)

15. The computer program product of claim 9, wherein providing the assistive action comprises providing an answer to a question.

16. The computer program product of claim 9, wherein providing the assistive action comprises playing a demonstration video.

17. The computer program product of claim 9, wherein providing the assistive action comprises describing a purpose of the interaction.

18. The computer program product of claim 9, wherein providing the assistive action comprises calling an action.

19. A computer system comprising a processor and one or more computer readable storage media, and program instructions collectively stored on the one or more computer readable storage media, the program instructions executable by the processor to cause the processor to perform operations comprising:
monitoring a digital channel to detect user activity;
performing a task demonstration within the digital channel;
generating, according to a granularity profile, an event stream from the task demonstration within the digital channel based on the user activity detected;
forming a collaboration context based on the event stream;
defining a collaboration by associating an assistive action with the collaboration context;
transforming the collaboration context into a conversational model;
evaluating an interaction session within the digital channel for an interaction that matches the collaboration context; and
providing the assistive action corresponding to the collaboration context via the conversational model upon detection of the interaction that matches the collaboration context.

20. The computer system of claim 19, 9, wherein providing the assistive action comprises at least one of: providing an answer to a question, playing a demonstration video, describing a purpose of the interaction, and calling an action.

21. The computer-implemented method of claim 1, wherein the granularity profile comprises at least one of: a coarse granularity profile, a medium granularity profile, and a granular granularity profile.

22. The computer program product of claim 9, wherein the granularity profile comprises at least one of: a coarse granularity profile, a medium granularity profile, and a granular granularity profile.
